(19) United States
(12) Patent Application Publication
(10) Pub. No.: US 2025/0385551 A1
(43) Pub. Date: Dec. 18, 2025

(54) WIRELESS POWER TRANSFER DEVICE

(71) Applicant: DENSO CORPORATION, Kariya-city (JP)

(72) Inventors: Kazuyoshi OBAYASHI, Kariya-city (JP); Keisuke TANI, Kariya-city (JP); Masaki KANESAKI, Kariya-city (JP); Masaya TAKAHASHI, Kariya-city (JP); Yusei NAKAYASHIKI, Kariya-city (JP); Nobuhisa YAMAGUCHI, Kariya-city (JP)

(73) Assignee: DENSO CORPORATION, Kariya-city (JP)

(21) Appl. No.: 19/316,209

(22) Filed: Sep. 2, 2025

Related U.S. Application Data
(63) Continuation of application No. PCT/JP2024/005962, filed on Feb. 20, 2024.

(30) Foreign Application Priority Data
Mar. 2, 2023 (JP) 2023-031689

(51) Int. Cl. H02J 50/12

(52) U.S. Cl. CPC H02J 50/12

(57) ABSTRACT

A wireless power transfer device includes: a power transmitting resonant circuit including a power transmitting coil and a power transmitting capacitor; a switching circuit switching a state of the power transmitting resonant circuit between a resonant state and a non-resonant state; and a determination circuit determining whether a facing state in which the power transmitting coil faces the power receiving coil or a non-facing state in which the power transmitting coil does not face the power receiving coil is occurring. After determining that either one of the non-facing state and the facing state transitions to the other one, the switching circuit performs switching process to switch from either one of the non-resonant state and the resonant state to the other one within a voltage zero-crossing range including a voltage zero-crossing point and a current zero-crossing range including a current zero-crossing point of the power transmitting coil or power transmitting capacitor.

### CROSS-REFERENCE TO RELATED APPLICATION

The present application is a continuation application of International Application No. PCT/JP2024/005962, filed on Feb. 20, 2024, which claims priority to Japanese Patent Application No. 2023-31689, filed on Mar. 2, 2023. The contents of these applications are incorporated herein by reference in their entirety.

### BACKGROUND

### Technical Field

The present disclosure relates to a wireless power transfer device.

### Background Art

In the related art, a wireless power transfer device is disclosed which includes a power transmitting resonator including a power transmitting coil and a power transmitting resonant capacitor, in which settings are configured so that in a facing state in which a power receiving coil is in opposition to the power transmitting coil, the power transmitting resonator is set to a resonant state, whereas in a non-facing state, the power transmitting resonator deviates from the resonant state. In a case of a transition from the non-facing state to the facing state, a capacitance of the power transmitting resonant capacitor is changed to a capacitance larger than a capacitance in the non-facing state.

### SUMMARY

In the present disclosure, provided is a wireless power transfer device as the following. The wireless power transfer device includes: a power transmitting resonant circuit including a power transmitting coil and a power transmitting capacitor; a switching circuit that switches a state of the power transmitting resonant circuit between a resonant state and a non-resonant state; and a determination circuit that determines whether a facing state in which the power transmitting coil faces the power receiving coil or a non-facing state in which the power transmitting coil does not face the power receiving coil is occurring, in which after the determination circuit determines that either one of the non-facing state and the facing state transitions to the other of the non-facing state and the facing state, the switching circuit performs a switching process to switch from either one of the non-resonant state and the resonant state to the other of the non-resonant state and the resonant state within a voltage zero-crossing range including a voltage zero-crossing point of the power transmitting coil or the power transmitting capacitor and a current zero-crossing range including a current zero-crossing point of the power transmitting coil or the power transmitting capacitor.

### BRIEF DESCRIPTION OF THE DRAWINGS

The above and other objects, features, and advantages of the present disclosure will become more apparent from the following detailed description made with reference to the accompanying drawings. The drawings are:

FIG. 1 is a circuit diagram of a wireless power transfer system;

FIG. 2 is a diagram illustrating a positional relationship between a power transmitting coil and a power receiving coil;

FIG. 3 is a flowchart diagram of a state changing process;

FIG. 4 is a circuit diagram of a determination circuit;

FIG. 5 is a waveform diagram of a signal Sig 4 and a capacitor voltage;

FIG. 6 is a waveform diagram of a detected voltage, a coil current, and a capacitor current according to a second embodiment;

FIG. 7 is a circuit diagram of a power transmission device according to a third embodiment;

FIG. 8 is a circuit diagram of a power transmission device according to a fourth embodiment;

FIG. 9 is a circuit diagram of a determination circuit according to the fourth embodiment;

FIG. 10 is a circuit diagram of a power transmission device according to a fifth embodiment;

FIG. 11 is a circuit diagram of a power transmission device according to a sixth embodiment;

FIG. 12 is a circuit diagram of a power transmission device according to a seventh embodiment; and

FIG. 13 is a circuit diagram of a power transmission device according to an eighth embodiment.

### DETAILED DESCRIPTION OF THE PREFERRED EMBODIMENTS

[PTL 1] JP 2021-23094 A

For the above-described wireless power transfer device, there is a concern that changing the capacitance of the power transmitting resonant capacitor to a capacitance larger than the capacitance in the non-facing state causes noises such as radiated noise and conducted noise. The present disclosure may be implemented as the following aspects.

In an aspect of the present disclosure, a wireless power transfer device is provided. The wireless power transfer device includes: a power transmitting resonant circuit including a power transmitting coil and a power transmitting capacitor; a switching circuit configured to switch a state of the power transmitting resonant circuit between a resonant state and a non-resonant state by changing at least either one of an inductance of the power transmitting coil or a capacitance value of the power transmitting capacitor; and a determination circuit configured to determine whether a facing state in which the power transmitting coil faces the power receiving coil or a non-facing state in which the power transmitting coil does not face the power receiving coil is occurring, in which the switching circuit is configured to, after the determination circuit determines that either one of the non-facing state and the facing state transitions to another one of the non-facing state and the facing state, perform a switching process to switch from either one of the non-resonant state and the resonant state to the other of the non-resonant state and the resonant state within either one of (i) a predetermined voltage zero-crossing range including a voltage zero-crossing point of at least either one of the power transmitting coil or the power transmitting capacitor and (ii) a predetermined current zero-crossing range including a current zero-crossing point of at least either one of the power transmitting coil or the power transmitting capacitor.

According to the above aspect, in switching the inductance of the power transmitting coil or the capacitance value of the power transmitting capacitor, the switching circuit performs the switching within the voltage zero-crossing range or the current zero-crossing range, which makes it possible to reduce a rapid change in the current value flowing through the power transmitting resonant circuit. Therefore, it is possible to reduce the generation of noises such as radiated noise and conducted noise.

### A. First Embodiment

A1. Circuit Configuration of Wireless power transfer System:

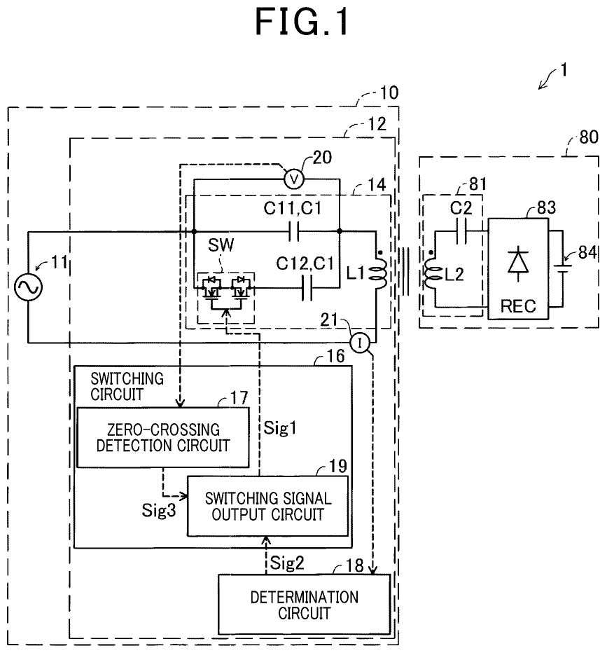

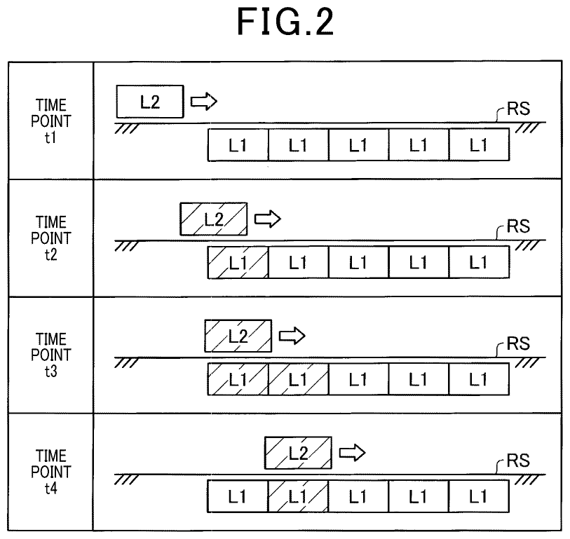

As illustrated in FIG. 1, a wireless power transfer system 1 includes a power transmission device 10, which serves as a wireless power transfer device, and a power receiving device 80. In the present embodiment, the power transmission device 10 is buried beneath a road RS (FIG. 2). The power receiving device 80 is mounted to a vehicle as a moving body that travels on the road RS. During traveling of the vehicle, power is supplied to the power receiving device 80 from the power transmission device 10. Here, “during traveling” includes a case where the vehicle is moving and a case where the vehicle is stopped to wait for a signal, or the like. The vehicle may be configured as, for example, an electric vehicle or a hybrid vehicle.

It should be noted that the moving body equipped with the power receiving device 80 is not limited to a vehicle that travels on the road RS and may be, for example, an AGV (automated guided vehicle), a mobile robot, or the like. Moreover, the power transmission device 10 may be installed not beneath the road RS, but in a sidewalk or a parking lot adjacent to the road RS or on a road surface in a route where an AGV is to travel or a lateral side vertical to the road surface in the route.

The power transmission device 10 includes a power transmitting circuit 12 and an alternating-current power supply 11 that supplies power to the power transmitting circuit 12. The power transmitting circuit 12 includes a power transmitting resonant circuit 14. It should be noted that a plurality of power transmitting circuits 12 are connected to the alternating-current power supply 11 in parallel with the alternating-current power supply 11, although the illustration thereof is omitted in FIG. 1. The alternating-current power supply 11 is configured to be able to supply power to a plurality of power transmitting resonant circuits 14. A plurality of power transmitting coils L1 are arranged along an extending direction of the road RS.

The alternating-current power supply 11 applies an alternating-current power with a predetermined operating frequency to the power transmitting resonant circuit 14. In the present embodiment, the operating frequency is 85 kHz. The power transmitting resonant circuit 14 includes a power transmitting coil L1, a power transmitting capacitor C1, and a switch SW. The power transmitting capacitor C1 includes a first power transmitting capacitor C11 and a second power transmitting capacitor C12. The first power transmitting capacitor C11 is connected in series to the power transmitting coil L1. The switch SW is connected in series to the second power transmitting capacitor C12. A connected body of the second power transmitting capacitor C12 and the switch SW is connected in parallel to the first power transmitting capacitor C11. In the present embodiment, the switch SW is a bidirectional switch provided by two MOSFETs with the respective source terminals connected.

In the present embodiment, a capacitance value of the first power transmitting capacitor C11 is smaller than a capacitance value of the second power transmitting capacitor C12. A capacitance value of the power transmitting capacitor C1 is to be switched between a first capacitance value and a second capacitance value, which is smaller than the first capacitance value, by switching a state of the switch SW between an electrically continuous state and an electrically discontinuous state. Specifically, in a case where the switch SW is in the electrically continuous state, the capacitance value of the power transmitting capacitor C1 becomes a first capacitance value, which is a combined capacitance value of the first power transmitting capacitor C11 and the second power transmitting capacitor C12. In contrast, in a case where the switch SW is in the electrically discontinuous state, the capacitance value of the power transmitting capacitor C1 becomes a second capacitance value, which is a capacitance value of the first power transmitting capacitor C11. The capacitance value of the power transmitting capacitor C1 is then to be switched to either one of the first capacitance value and the second capacitance value by a switching signal Sig 1 outputted from a later-described switching signal output circuit 19.

In a case where the power transmitting coil L1 and a power receiving coil L2 are magnetically coupled and the power transmitting capacitor C1 has the first capacitance value, the power transmitting resonant circuit 14 enters a resonant state at the operating frequency. In other words, the first capacitance value of the power transmitting capacitor C1 is set to a value at which a resonant frequency of the power transmitting resonant circuit 14 matches the operating frequency. In contrast, in a case where the power transmitting capacitor C1 has the second capacitance value, the resonant frequency of the power transmitting resonant circuit 14 deviates from the operating frequency, so that the power transmitting resonant circuit 14 enters a non-resonant state at the operating frequency.

The power transmitting circuit 12 further includes a switching circuit 16, a determination circuit 18, a voltage sensor 20, which serves as a second voltage sensor, and a current sensor 21. The switching circuit 16 includes a zero-crossing detection circuit 17 and a switching signal output circuit 19. The voltage sensor 20 detects a voltage value of the first power transmitting capacitor C11 and outputs a detected voltage value, which is the voltage value having been detected, to the zero-crossing detection circuit 17. The current sensor 21 detects a current value flowing through the power transmitting coil L1 and outputs a detected current value, which is the current value having been detected, to the determination circuit 18.

Using the detected current value inputted from the current sensor 21, the determination circuit 18 determines whether a facing state in which the power transmitting coil L1 is in opposition to the power receiving coil L2 or a non-facing state in which the power transmitting coil L1 is not in opposition to the power receiving coil L2 is occurring. Then, in response to determining a transition from either one of the facing state and the non-facing state to the other of the facing state and the non-facing state, the determination circuit 18 outputs a state signal Sig 2 to the switching signal output circuit 19.

Using the detected voltage value inputted from the voltage sensor 20, the zero-crossing detection circuit 17 detects a voltage zero-crossing point, which is the time when the voltage value of the first power transmitting capacitor C11 reaches zero V. Then, in response to detecting the voltage zero-crossing point, the zero-crossing detection circuit 17 outputs a zero-crossing signal Sig 3 to the switching signal output circuit 19.

Using the state signal Sig 2 inputted from determination circuit 18 and the zero-crossing signal Sig 3 inputted from the zero-crossing detection circuit 17, the switching signal output circuit 19 outputs the switching signal Sig 1 to the switch SW. This makes it possible to reduce the generation of noise as described later in detail.

The power receiving device 80 includes a power receiving resonant circuit 81, a rectifier circuit 83, and a battery 84. The power receiving resonant circuit 81 includes the power receiving coil L2 and a power receiving capacitor C2 connected in series to the power receiving coil L2. The rectifier circuit 83 rectifies an alternating-current power received by the power receiving resonant circuit 81 and supplies a rectified direct-current power to the battery 84. In the present embodiment, the rectifier circuit 83 is implemented by a diode bridge.

In a case where the power transmitting coil L1 and the power receiving coil L2 are magnetically coupled, the resonant frequency of the power transmitting resonant circuit 14 and a resonant frequency of the power receiving resonant circuit 81 are set substantially the same. This makes it possible to perform wireless power transfer to the power receiving device 80 with the assistance of magnetic resonance between the power transmitting coil L1 and the power receiving coil L2. As described above, the direct-current power outputted from the power receiving resonant circuit 81 is rectified through the rectifier circuit 83 and supplied to the battery 84.

The switching circuit 16 causes the power transmitting circuit 12 to be set to either a standby state or a power supply state. Specifically, the standby state refers to a state in which the switch SW is set to the electrically discontinuous state and, consequently, the power transmitting resonant circuit 14 is set to the non-resonant state. In contrast, the power supply state refers to a state in which the switch SW is set to the electrically continuous state and, consequently, the power transmitting resonant circuit 14 is set to the resonant state. The current flowing through the power transmitting coil L1 in the power supply state is larger than the current flowing through the power transmitting coil L1 in the standby state.

### A2. Standby State and Power Transmitting State:

As illustrated in FIG. 2, the power transmitting coils L1 are arranged in the extending direction of the road RS and the power receiving coil L2 is to be wirelessly supplied with power from the nearest one of the power transmitting coils L1. In FIG. 2, the power transmitting coil L1 and the power receiving coil L2 supplying and receiving power are hatched. In other words, non-hatched ones of the power transmitting coils L1 are the power transmitting coils L1 in the standby state, whereas hatched one of the power transmitting coils L1 is the power transmitting coil L1 in a power transmitting state. An arrow in FIG. 2 shows a traveling direction of the vehicle equipped with the power receiving coil L2.

At a “time point t1” shown in FIG. 2, the approach of the power receiving coil L2 toward the arranged power transmitting coils L1 is depicted. As shown at a “time point t2” in FIG. 2, as the power receiving coil L2 approaches the power transmitting coil L1 at the end, the wireless power transfer is started. At a “time point t3” in FIG. 2, the power receiving coil L2 is also supplied with power from the power transmitting coil L1 at the end. As shown at a “time point t4” in FIG. 2, as a distance between the power transmitting coil L1 adjacent to the power transmitting coil L1 at the end and the power receiving coil L2 becomes shorter than a distance between the power transmitting coil L1 at the end and the power receiving coil L2 with a forward movement of the vehicle, the power transmitting coil L1 performing the transmission/reception of power is switched from the power transmitting coil L1 at the end to the power transmitting coil L1 adjacent to the power transmitting coil L1 at the end.

It should be noted that the transmission/reception of power is to be performed not only in a state in which the whole of the power transmitting coil L1 is in opposition to the power receiving coil L2 in a direction of a coil longitudinal axis of the power transmitting coil L1 as illustrated at the “time point t2” in FIG. 2 but also in a state in which only a part of the power transmitting coil L1 is in opposition to the power receiving coil L2 as illustrated at the “time point t2” in FIG. 2.

A case where the coil central axis of the power transmitting coil L1 is in alignment with a coil central axis of the power receiving coil L2 as illustrated at the “time point t3” in FIG. 2 is also referred to as “directly facing state”. A state in which a part of the power transmitting coil L1 and a part of the power receiving coil L2 are opposed in a coil central axis direction of the power transmitting coil L1 as illustrated at the “time point t2” in FIG. 2 is also referred to as “partially overlapping state”. The directly facing state and the partially overlapping state are collectively also referred to as “facing state”. In contrast, a state in which the power transmitting coil L1 and the power receiving coil L2 are not opposed in the coil central axis direction of the power transmitting coil L1 as illustrated at the “time point t1” in FIG. 2 is also referred to as “non-facing state.”

### A3. State Changing Process:

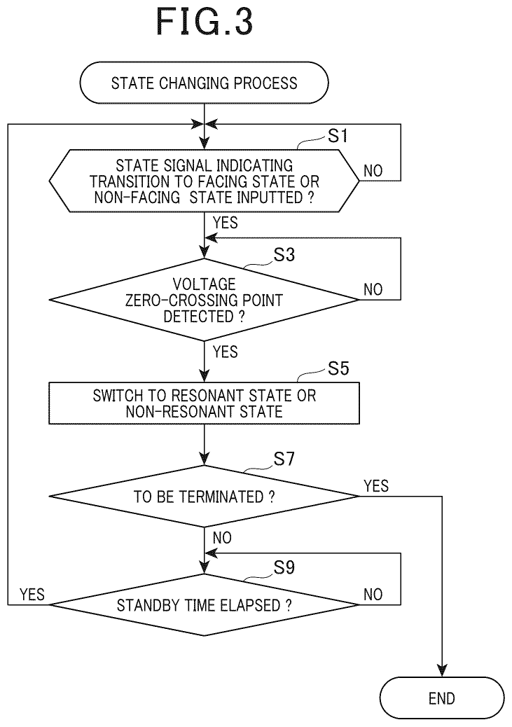

After activated by the supply of power, the switching circuit 16 performs a state changing process illustrated in FIG. 3. In the state changing process, the switching circuit 16 switches either one of the non-resonant state and the resonant state to the other of the non-resonant state and the resonant state within a predetermined voltage zero-crossing range, which includes the voltage zero-crossing point of the power transmitting coil L1 or the power transmitting capacitor C1, or within a predetermined current zero-crossing range, which includes a current zero-crossing point of the power transmitting coil L1 or the power transmitting capacitor C1. Performing the state changing process makes it possible to cause the target power transmitting coil L1 to start power supply to the power receiving coil L2 when the facing state is reached and cause the target power transmitting coil L1 to stop power supply to the power receiving coil L2 when the non-facing state is reached.

Here, the voltage zero-crossing range refers to a voltage range centered about the voltage zero-crossing point at which a capacitor voltage, which is a voltage of the power transmitting capacitor C1, reaches zero V as illustrated in FIG. 5. Specifically, the voltage range falls within 10% of the amplitude of an aimed capacitor voltage at which power supply is to be started. The aimed capacitor voltage at which power supply is to be started is determined in advance by experiment or the like. Likewise, for example, the current zero-crossing range of the power transmitting capacitor C1 refers to a current range centered about the current zero-crossing point at which a capacitor current, which is the current flowing through the power transmitting capacitor C1, reaches zero A. Specifically, the current range falls within 10% of the amplitude of an aimed capacitor current at which power supply is to be started. The aimed capacitor current at which power supply is to be started is determined in advance by experiment or the like.

Specifically, in state changing process, the switching circuit 16 switches either one of the non-resonant state and the resonant state to the other of the non-resonant state and the resonant state at the voltage zero-crossing point of the power transmitting capacitor C1 in the present embodiment.

As illustrated in FIG. 3, in Step S1, which is a determination process, the switching circuit 16 determines whether the state signal Sig 2 is inputted. The state signal Sig 2 indicates that either one of the non-facing state and the facing state transitions to the other of non-facing state and the facing state. As described above, in response to determining that a transition to the facing state or the non-facing state occurs, the determination circuit 18 outputs the state signal Sig 2 to the switching signal output circuit 19. Accordingly, in response to the state signal Sig 2 being inputted from the determination circuit 18, the switching circuit 16 determines that the determination circuit 18 determines that the transition to the facing state or the non-facing state occurs. In contrast, in a case where no state signal Sig 2 is inputted from the determination circuit 18, the switching circuit 16 determines that the determination circuit 18 determines that no transition to the facing state or the non-facing state occurs.

A coefficient of coupling of the power transmitting coil L1 and the power receiving coil L2 increases with the approach of the power transmitting coil L1 to the power receiving coil L2. The current flowing through the power transmitting coil L1 in the facing state is thus larger than the current flowing through the power transmitting coil L1 in the non-facing state. Accordingly, the determination circuit 18 determines that a transition to the facing state occurs in response to the detected current value from the current sensor 21 exceeding a predetermined first reference current value. Likewise, the determination circuit 18 determines that a transition to the non-facing state occurs in response to the detected current value from the current sensor 21 falling below a predetermined second reference current value. It should be noted that the first reference current value and the second reference current value may be the same value or different values.

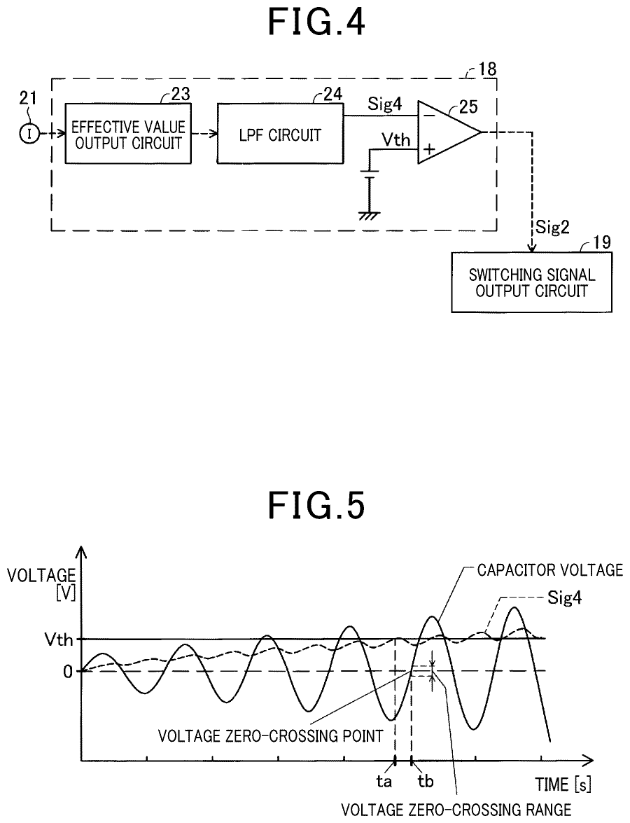

In more detail, the determination circuit 18 includes an effective value output circuit 23, an LPF circuit 24, and a differential amplifier circuit 25 as illustrated in FIG. 4. The effective value output circuit 23 outputs an effective value of the detected current value outputted from the current sensor 21 to the LPF circuit 24, which is a low-pass filter. The LPF circuit 24 inputs a signal Sig 4, from which a high-frequency component of the inputted signal is removed, to a negative terminal of the differential amplifier circuit 25. A reference voltage value Vth is to be inputted to a positive terminal of the differential amplifier circuit 25. The differential amplifier circuit 25 inputs a voltage value, which is provided by amplifying a voltage difference between the signal Sig 4 inputted from the LPF circuit 24 and the reference voltage value Vth, to the switching signal output circuit 19.

FIG. 5 illustrates, in a case where the power receiving coil L2 approaches the target power transmitting coil L1, a voltage waveform of the signal Sig 4 and a waveform of the capacitor voltage, which is the voltage of the first power transmitting capacitor C11. It should be noted that since the voltage sensor 20 detects the voltage of the first power transmitting capacitor C11, the capacitor voltage is, in other words, the detected voltage value from the voltage sensor 20. The horizontal axis in FIG. 5 represents time and the vertical axis represents voltage. As time progresses, a voltage value of the signal Sig 4 (FIG. 4) gradually increases with the approach of the power receiving coil L2 to the target power transmitting coil L1 as illustrated in FIG. 5. At a time point ta in FIG. 5, a difference between the signal Sig 4 and the reference voltage value Vth reaches substantially zero V. Here, the reference voltage value Vth, which is a voltage value determined in advance by experiment or the like, is the voltage value of the signal Sig 4 in a case where the supplied current flows through the power transmitting coil L1 in the facing state. The reference voltage value Vth is a value corresponding to the above-described first reference current value. At the time point ta, the determination circuit 18 outputs the state signal Sig 2, which is a signal of substantially zero V, to the switching signal output circuit 19.

It should be noted that in a case of a transition from the facing state to the non-facing state, the determination circuit 18 outputs the state signal Sig 2, which is the signal of substantially zero V, to the switching signal output circuit 19 in a similar manner to that described above. FIG. 4 illustrates a configuration of the determination circuit 18 in a case where the first reference current value is the same as the second reference current value for determining whether the facing state transitions to the non-facing state. Unlike the above, in a case where the second reference current value is different from the first reference current value, a value of the reference voltage value Vth to be inputted to the differential amplifier circuit 25 is changed.

As described above, in Step S1 in FIG. 3, in response to determining that the determination circuit 18 does not determine that either one of the non-facing state and the facing state transitions to the other of the non-facing state and the facing state, the switching circuit 16 repeatedly performs Step S1 until the transition to the non-facing state or the facing state is determined to occur. In response to the transition to the non-facing state or the facing state being determined to occur, the switching circuit 16 proceeds to Step S3 in the process.

In Step S3, the switching circuit 16 determines whether the zero-crossing detection circuit 17 detects the voltage zero-crossing point. Specifically, it is determined whether the zero-crossing signal Sig 3 is inputted from the zero-crossing detection circuit 17 to the switching signal output circuit 19. In response to the zero-crossing signal Sig 3 being inputted from the zero-crossing detection circuit 17, the switching circuit 16 determines that the voltage zero-crossing point is detected. In contrast, in response to no zero-crossing signal Sig 3 being inputted from the zero-crossing detection circuit 17, the switching circuit 16 determines that the voltage zero-crossing point is not detected. In response to determining that the voltage zero-crossing point is not detected, the switching circuit 16 repeatedly performs Step S3 until determining that the voltage zero-crossing point is detected. Then, in response to determining that the voltage zero-crossing point is detected, the switching circuit 16 performs switching from the non-resonant state to the resonant state or from the non-resonant state to the resonant state in Step S5, which is a switching process.

Specifically, in performing the switching from the non-resonant state to the resonant state, the switching signal output circuit 19 switches a voltage value of the switching signal Sig 1 from an OFF voltage to an ON voltage. Here, the OFF voltage refers to a voltage that sets the switch SW to the electrically discontinuous state. In contrast, the ON voltage is a voltage that sets the switch SW to the electrically continuous state. Contrarily, in performing the switching from the resonant state to the non-resonant state, the switching signal output circuit 19 switches the voltage value of the switching signal Sig 1 from the ON voltage to the OFF voltage.

Description will be made on Step S3 and Step S5 using FIG. 5. The voltage zero-crossing point refers to a point at which a waveform of the capacitor voltage, which is the voltage of the first power transmitting capacitor C11, intersects with a broken line representing zero V.

As described above, at the time point ta in FIG. 5, the signal Sig 4 matches the reference voltage value Vth, so that a transition to the facing state is determined to occur. Then, at a time point tb, which is the voltage zero-crossing point after the time point ta, the switch SW is switched from the electrically discontinuous state to the electrically continuous state. As seen from the above, the switch SW is switched to the electrically continuous state when the voltage of the first power transmitting capacitor C11 is near zero V, which makes it possible to reduce the generation of inrush current. Therefore, it is possible to reduce radiated noise or conducted noise. If the switch SW were switched to the electrically continuous state when the voltage of the first power transmitting capacitor C11 is not near zero V, the charge accumulated in the first power transmitting capacitor C11 would flow through the second power transmitting capacitor C12 at the moment when the switch SW is switched to the electrically continuous state, making inrush current prone to be generated. In this regard, in the present embodiment, the switch SW is switched to the electrically continuous state when the voltage of the first power transmitting capacitor C11 is near zero V, which makes it possible to reduce the generation of inrush current by virtue of a small amount of the charge accumulated in the first power transmitting capacitor C11.

It should be noted that in a case of a transition from the facing state to the non-facing state, the switch SW is also switched from the electrically continuous state to the electrically discontinuous state likewise at the voltage zero-crossing point after the transition to the non-facing state is determined to occur by performing Step S1 to Step S5. This makes it possible to reduce the generation of surge voltage. Therefore, it is possible to reduce the generation of radiated noise or conducted noise.

As another embodiment of the present embodiment, Step S5 may be performed not at the voltage zero-crossing point but within the voltage zero-crossing range excluding the voltage zero-crossing point. As long as the voltage value of the power transmitting capacitor C1 is within the voltage zero-crossing range, not limited to the voltage zero-crossing point, the charge accumulated in the first power transmitting capacitor C11 are small, which makes it possible to reduce the generation of inrush current.

In Step S7 in FIG. 3, the switching circuit 16 determines whether the state changing process is to be terminated. The switching circuit 16 determines, in response to the power supply thereto being stopped, that the state changing process is to be terminated. In contrast, the switching circuit 16 determines, in response to the power supply from the alternating-current power supply 11 being continued, that the state changing process is not to be terminated. In response to determining that the state changing process is to be terminated in Step S7, the switching circuit 16 terminates this processing routine.

In response to determining that the state changing process is not to be terminated in Step S7, the switching circuit 16 performs Step S5 and then determines whether a predetermined standby time has elapsed. The standby time refers to time provided for the purpose of preventing frequent state switching between the non-resonant state and the resonant state in a short time. The predetermined time is, for example, several μs. This makes it possible to stabilize operation of the power transmitting resonant circuit 14 even in a case where the value of the signal Sig 4 oscillates near the reference voltage value Vth due to the occurrence of chattering.

Specifically, the switching circuit 16 includes a non-illustrated timer circuit. The timer circuit measures the elapsed time after Step S5 is performed. The switching circuit 16 then determines whether the standby time has elapsed using the timer circuit. In response to the standby time being determined not to have elapsed in Step S9, Step S9 is repeatedly performed until the standby time is determined to have elapsed. In contrast, in response to the standby time being determined to have elapsed in Step S9, the process returns to Step S1 for the purpose of a subsequent switching of the power transmitting resonant circuit 14.

According to the first embodiment described hereinabove, the switching circuit 16 performs the switching process at the voltage zero-crossing point in Step S5 after the determination circuit 18 determines that either one of the non-facing state and the facing state transitions to the other of the non-facing state and the facing state in Step S1. This makes it possible to reduce the generation of radiated noise or conducted noise.

The power transmission device 10 also includes the voltage sensor 20 for detecting the voltage value of the power transmitting capacitor C1 and the switching circuit 16 detects the voltage zero-crossing point using the detected voltage value from the voltage sensor 20. This makes it possible to accurately detect the voltage zero-crossing point.

The power transmission device 10 also includes the effective value output circuit 23 that outputs the effective value of the detected voltage value from the voltage sensor 20. This makes it possible to accurately detect the voltage zero-crossing point.

In the state changing process, the switching circuit 16 also repeatedly performs Step S1 and Step S5 to perform switching between the resonant state and the non-resonant state. Then, after performing Step S5, the switching circuit 16 performs Step S9 and, consequently, performs Step S1 after the elapse of the standby time. This makes it possible to prevent switching between the resonant state and the non-resonant state in a short time.

The switching circuit 16 also switches the state of the power transmitting resonant circuit 14 between the resonant state and the non-resonant state by switching the capacitance value of the power transmitting capacitor C1 between the first capacitance value and the second capacitance value using the switch SW. This makes it possible to accurately set the state of the power transmitting resonant circuit 14.

### B. Modifications of First Embodiment

(B1) In the above-described first embodiment, the determination circuit 18 detects the voltage zero-crossing point using the detected voltage value from the voltage sensor 20. The switching signal output circuit 19 then performs switching at the voltage zero-crossing point in switching the power transmitting resonant circuit 14 either from the resonant state to the non-resonant state, or from the non-resonant state to the resonant state. As another form, the zero-crossing detection circuit 17 may detect the current zero-crossing point, which is a zero-crossing point of the current flowing through the first power transmitting capacitor C11, using the detected current value from the current sensor 21 in addition to the voltage zero-crossing point. Then, in some forms, the switching circuit 16 may perform switching at the voltage zero-crossing point in the case of switching the power transmitting resonant circuit 14 from the non-resonant state to the resonant state and perform switching at the current zero-crossing point in the case of switching it from the resonant state to the non-resonant state. In the case of switching from the resonant state to the non-resonant state, the switching is performed at the current zero-crossing point, which makes it possible to reduce the generation of the surge voltage. In the case of the resonant state, the switch SW is in the electrically continuous state, which is a state in which current may flow through the second power transmitting capacitor C12. Here, in the state in which current flows through the second power transmitting capacitor C12, switching the switch SW to the electrically discontinuous state leads to a rapid change in current value, making surge voltage prone to be generated. Accordingly, the switch SW is switched to the electrically discontinuous state at the current zero-crossing point, which makes it possible to reduce the generation of surge voltage. Moreover, in some forms, switching may be performed at the current zero-crossing point in switching the power transmitting resonant circuit 14 either from the non-resonant state to the resonant state, or from the resonant state to the non-resonant state.

(B2) Moreover, in the above-described first embodiment, the voltage sensor 20 detects the voltage of the first power transmitting capacitor C11. As another form, the voltage sensor 20, which serves as a first voltage sensor, may be attached at a position to detect the voltage of the power transmitting coil L1. Then, the zero-crossing detection circuit 17 may estimate the voltage zero-crossing point of the first power transmitting capacitor C11 using the detected voltage value of the power transmitting coil L1. Since the power transmitting resonant circuit 14 is a series resonant circuit, the current value flowing through the first power transmitting capacitor C11 and the current value flowing through the power transmitting coil L1 are the same. Then, the waveform of the voltage of the first power transmitting capacitor C11 lags the waveform of the current flowing through it by a phase of x/2 rad. In contrast, the waveform of the voltage of the power transmitting coil L1 leads the waveform of the current flowing through it by a phase of x/2 rad. The waveform of the voltage of the first power transmitting capacitor C11 and the waveform of the voltage of the power transmitting coil L1 are thus in opposite phase and the voltage zero-crossing points thereof match. Therefore, it is possible to estimate the voltage zero-crossing point of the first power transmitting capacitor C11 using the detected voltage value of the power transmitting coil L1.

### C. Second Embodiment

In the first embodiment, the zero-crossing detection circuit 17 detects the voltage zero-crossing point using the detected voltage value from the voltage sensor 20. In the present embodiment, the zero-crossing detection circuit 17 detects the current zero-crossing point using the detected voltage value from the voltage sensor 20. A circuit configuration of the power transmission device 10 is similar to that of the first embodiment. The same components as in the first embodiment are labelled with the same reference numerals and a description thereof is omitted, if necessary.

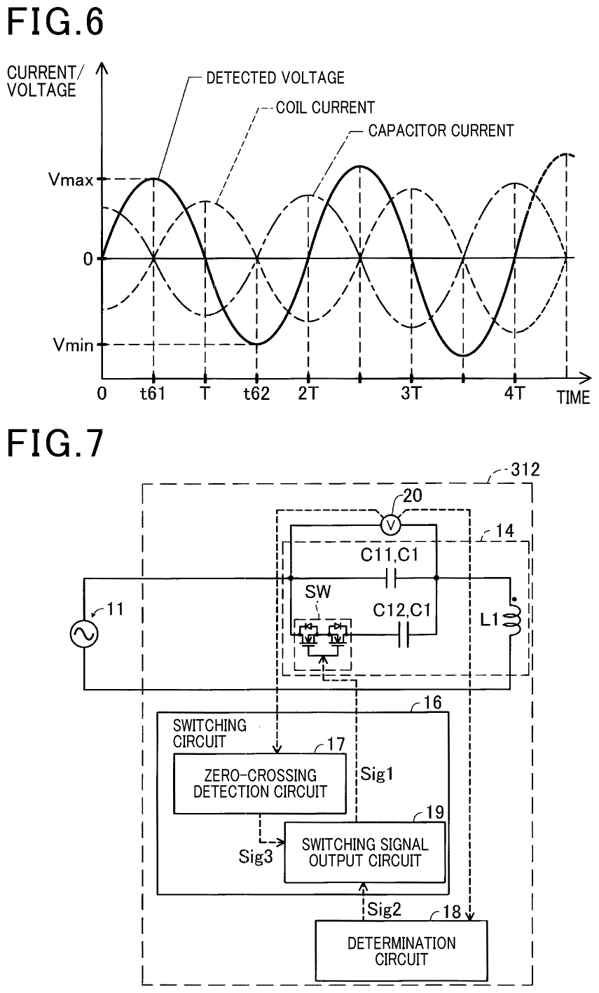

As illustrated in FIG. 6, the waveform of the capacitor current, which is the current flowing through the first power transmitting capacitor C11, leads the waveform of the voltage flowing through it by a phase of π/2 rad. Thus, the current zero-crossing point, at which the current flowing through the first power transmitting capacitor C11 reaches zero A, is reached when the detected voltage value reaches its maximum, which is illustrated at a time point t61 in FIG. 6, and when the detected voltage value reaches its minimum, which is illustrated at a time point t62. When the detected voltage value from the voltage sensor 20 reaches the maximum value and the maximum value, the zero-crossing detection circuit 17 according to the present embodiment outputs the zero-crossing signal Sig 3 indicating the current zero-crossing point to the switching signal output circuit 19. The switching circuit 16 then switches the state of the power transmitting resonant circuit 14 between the non-resonant state and the resonant state at the current zero-crossing point. This makes it possible to reduce the generation of radiated noise or conducted noise attributed to the switching of the switch SW.

According to the second embodiment described hereinabove, the switching circuit 16 estimates the current value of the power transmitting capacitor C1 using the detected voltage value from the voltage sensor 20, which serves as the second voltage sensor for detecting the voltage value of the power transmitting capacitor C1, and performs the switching process at the current zero-crossing point of the power transmitting capacitor C1 detected using the estimated current value of the power transmitting capacitor C1. This produces similar effects to those of the above-described first embodiments.

### D. Modification of Second Embodiment

In the above-described second embodiment, the voltage sensor 20 detects the voltage of the first power transmitting capacitor C11. As another form, the voltage sensor 20 may be attached at a position to detect the voltage of the power transmitting coil L1. Then, the zero-crossing detection circuit 17 may estimate the current zero-crossing point of the first power transmitting capacitor C11 using the detected voltage value of the power transmitting coil L1.

As illustrated in FIG. 6, the waveform of the coil current, which is the current flowing through the power transmitting coil L1, lags the waveform of the voltage flowing through it by a phase of x/2 rad. The current flowing through the power transmitting coil L1 thus reaches zero A when the detected voltage value reaches its maximum and when the detected voltage value reaches its minimum. Since the current value flowing through the first power transmitting capacitor C11 and the current value flowing through the power transmitting coil L1 are the same, the moment when the current flowing through the power transmitting coil L1 reaches zero A matches the current zero-crossing point of the first power transmitting capacitor C11. Therefore, the voltage sensor 20 may be attached at the position to detect the voltage of the power transmitting coil L1.

### E. Third Embodiment

As illustrated in FIG. 7, a power transmitting circuit 312 according to the present embodiment includes no current sensor 21. The determination circuit 18 determines whether the facing state or the non-facing state is occurring using the detected voltage value from the voltage sensor 20, which serves as the second voltage sensor that detects the voltage value of the first power transmitting capacitor C11. As described above, the coefficient of coupling of the power transmitting coil L1 and the power receiving coil L2 increases with a transition from the non-facing state to the facing state, so that the current flowing through the power transmitting coil L1 increases and the voltage of the first power transmitting capacitor C11 also increases. Accordingly, in response to the detected voltage value from the voltage sensor 20 exceeding the predetermined the first reference voltage value, the determination circuit 18 determines that the non-facing state transitions to the facing state. In contrast, in response to the detected voltage value from the voltage sensor 20 falling below the predetermined second reference voltage value, the determination circuit 18 determines that the facing state transitions to the non-facing state. It should be noted that the first reference voltage value and the second reference voltage value may be the same value or different values. Moreover, the voltage sensor 20 may be attached not at the position to detect the voltage of the first power transmitting capacitor C11 but at the position to detect the voltage of the power transmitting coil L1. As seen from the above, the determination circuit 18 can determine whether the facing state or the non-facing state is occurring using the detected voltage value of the power transmitting coil L1.

### F. Fourth Embodiment

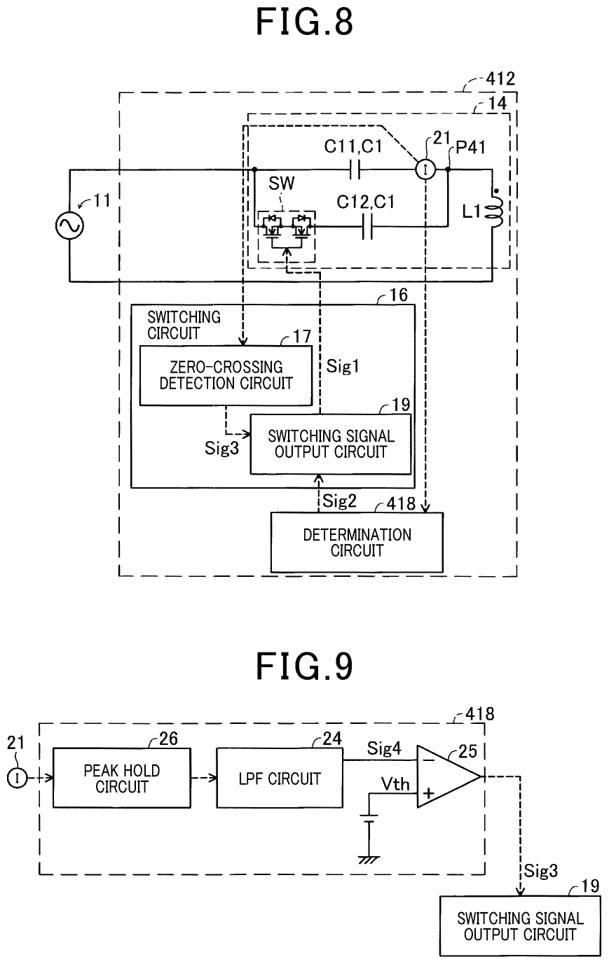

As illustrated in FIG. 8, a power transmitting circuit 412 according to a fourth embodiment is different from that of the first embodiment in the installation location of the current sensor 21 and a circuit configuration of the determination circuit 18. Moreover, the power transmitting circuit 412 according to the present embodiment does not include the voltage sensor 20, which is included in the power transmitting circuit 12 according to the first embodiment. The same components as in the above-described embodiments are labelled with the same reference numerals and a detailed description thereof is omitted, if necessary.

In the present embodiment, the current sensor 21, which serves as the first current sensor and the second current sensor, is disposed between the first power transmitting capacitor C11 and the power transmitting coil L1. Although different in installation location, the current sensor 21 is the same as that of the first embodiment in that the current sensor 21 detects the current flowing through the power transmitting coil L1. It should be noted that in the present embodiment, the current sensor 21 is disposed on a wiring line connecting a junction point P41 and the first power transmitting capacitor C11, the junction point P41 being where a wiring line connecting the first power transmitting capacitor C11 and the power transmitting coil L1 and a wiring line connecting the second power transmitting capacitor C12 and the power transmitting coil L1 merge. As an alternative form to the above form, the current sensor 21 may be disposed on a wiring line connecting the junction point P41 and the power transmitting coil L1.

The determination circuit 418 according to the present embodiment is different from that of the first embodiment in that the determination circuit 418 includes, in place of the effective value output circuit 23 according to the first embodiment, a peak hold circuit 26 that outputs the maximum value of the detected current value from the current sensor 21 as illustrated in FIG. 9. The determination circuit 418 determines whether the facing state or the non-facing state is occurring using the maximum value of the detected current value from the current sensor 21 as in the first embodiment.

It should be noted that as another embodiment of the determination circuit 418 may include, in place of the peak hold circuit 26, a rectifier circuit that outputs a rectified wave of the detected current value from the current sensor 21.

The zero-crossing detection circuit 17 according to the present embodiment detects the current zero-crossing point, which is the time when the current value of the first power transmitting capacitor C11 reaches zero, using the detected current value from the current sensor 21. Then, in Step S3 of the state changing process, the switching circuit 16 is different from that of the first embodiment in that the switching circuit 16 determines whether the current zero-crossing point is detected.

In the present embodiment, the state of the switch SW is also switched between the non-resonant state and the resonant state near the current zero-crossing point by performing the switching process. It is thus possible to reduce radiated noise or conducted noise as in the first embodiment. Moreover, in the present embodiment, a primary determination circuit determines whether the facing state or the non-facing state is occurring using the current sensor 21 for detecting the current zero-crossing point. It is thus possible to reduce the number of sensors installed in a power transmitting circuit 212.

According to the fourth embodiment described hereinabove, the determination circuit 18 determines whether the facing state or the non-facing state is occurring using the detected current value from the current sensor 21. It is thus possible to reduce the number of sensors. Moreover, the power transmission device 10 includes the peak hold circuit 26 that outputs the maximum value of the detected current value from the current sensor 21. This makes it possible to accurately detect the current zero-crossing point.

### G. Fifth Embodiment

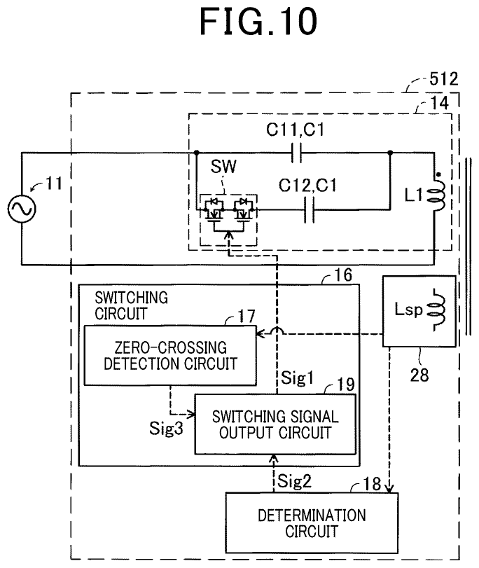

As illustrated in FIG. 10, a power transmitting circuit 512 according to a fifth embodiment is different from that of the fourth embodiment in that the power transmitting circuit 512 includes a magnetic sensor 28 in place of the current sensor 21. The same components as in the above-described embodiments are labelled with the same reference numerals and a detailed description thereof is omitted, if necessary.

The magnetic sensor 28 is disposed in the vicinity of the power transmitting coil L1. The magnetic sensor 28 detects a magnitude of a magnetic flux in the vicinity of the power transmitting coil L1. Specifically, the magnetic sensor 28 incorporates a detection coil Lsp, which is disposed in the vicinity of the power receiving coil L2, and detects a magnitude of a magnetic flux density using a change in the current flowing through the detection coil Lsp. The magnetic sensor 28 outputs the detected magnetic flux density, which is a detection value having been detected, indicating the magnitude of the magnetic flux density to the determination circuit 18.

The determination circuit 18 determines whether the facing state or the non-facing state is occurring using the detected magnetic flux density inputted from the magnetic sensor 28. Moreover, the zero-crossing detection circuit 17 detects the voltage zero-crossing point or the current zero-crossing point of the first power transmitting capacitor C11 using the detected magnetic flux density inputted from the magnetic sensor 28. Specifically, for example, in detecting the voltage zero-crossing point, a phase shift between a voltage waveform of the first power transmitting capacitor C11 and the waveform of the detected magnetic flux density of the detection coil Lsp is obtained in advance by experiment or the like and the voltage zero-crossing point is estimated from the waveform of the detected magnetic flux density. In detecting the current zero-crossing point, the current zero-crossing point is likewise estimated from the waveform of the detected magnetic flux density.

According to the fifth embodiment described hereinabove, the power transmission device 10 includes the magnetic sensor 28 and the switching circuit 16 detects the voltage zero-crossing point or the current zero-crossing point using the detected magnetic flux density from the magnetic sensor 28. This makes it possible to accurately detect the voltage zero-crossing point or the current zero-crossing point. Moreover, the determination circuit 18 determines whether the facing state or the non-facing state is occurring using the detected magnetic flux density from the magnetic sensor 28. It is thus possible to reduce the number of sensors.

### H. Sixth Embodiment

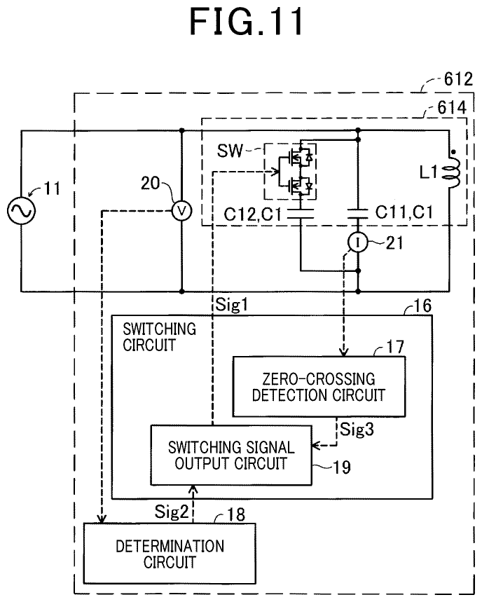

A power transmitting circuit 612 according to a sixth embodiment according to FIG. 11 is different from the above-described embodiments in the circuit configuration of a power transmitting resonant circuit 614. The same components as in the above-described embodiments are labelled with the same reference numerals and a detailed description thereof is omitted, if necessary.

The power transmitting resonant circuit 614 according to the present embodiment is a parallel resonant circuit in which the power transmitting coil L1 is connected in parallel to the power transmitting capacitor C1. The current sensor 21, which serves as the second current sensor, detects the current flowing through the first power transmitting capacitor C11. The voltage sensor 20 detects the voltage of the power transmitting coil L1.

The determination circuit 18 determines whether the facing state or the non-facing state is occurring using the detected voltage value from the voltage sensor 20. The zero-crossing detection circuit 17 detects the current zero-crossing point of the first power transmitting capacitor C11 using the detected current value from the current sensor 21. The switching circuit 16 performs switching at the current zero-crossing point in switching the power transmitting resonant circuit 14 either from the resonant state to the non-resonant state, or from the non-resonant state to the resonant state.

### I. Modification of Sixth Embodiment

(I1) In the above-described sixth embodiment, the switching circuit 16 performs switching at the current zero-crossing point in switching the power transmitting resonant circuit 14 either from the resonant state to the non-resonant state, or from the non-resonant state to the resonant state. As another form, the switching circuit 16 may perform switching at the current zero-crossing point in switching the power transmitting resonant circuit 14 from the resonant state to the non-resonant state and perform switching at the voltage zero-crossing point in switching it from the non-resonant state to the resonant state. In this case, the zero-crossing detection circuit 17 may detect the voltage zero-crossing point using the detected voltage value from the voltage sensor 20 or may estimate the voltage zero-crossing point based on the detected current value from the current sensor 21. Alternatively, the switching circuit 16 may perform switching at the voltage zero-crossing point in switching the power transmitting resonant circuit 14 either from the resonant state to the non-resonant state, or from the non-resonant state to the resonant state.

### J. Seventh Embodiment

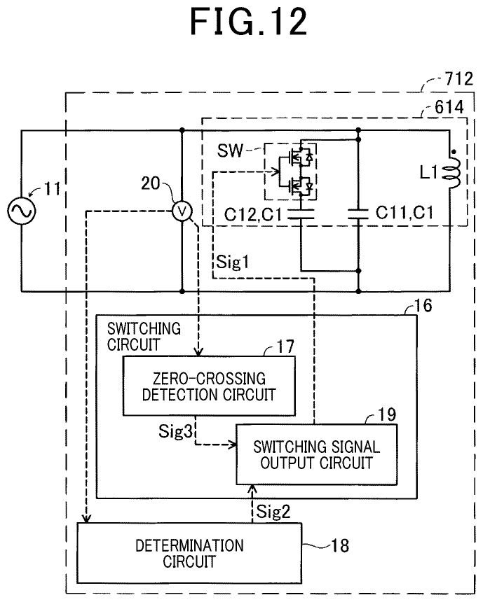

A power transmitting circuit 712 according to a seventh embodiment according to FIG. 12 is different from the above-described sixth embodiment in that the power transmitting circuit 712 does not include the current sensor 21, which is included in the power transmitting circuit 612 according to the sixth embodiment. The same components as in the above-described embodiments are labelled with the same reference numerals and a detailed description thereof is omitted, if necessary.

The zero-crossing detection circuit 17 according to the present embodiment detects the voltage zero-crossing point of the first power transmitting capacitor C11 using the detected voltage value from the voltage sensor 20, which serves as the first voltage sensor and the second voltage sensor. This makes it possible to reduce the number of sensors.

### K. Eighth Embodiment

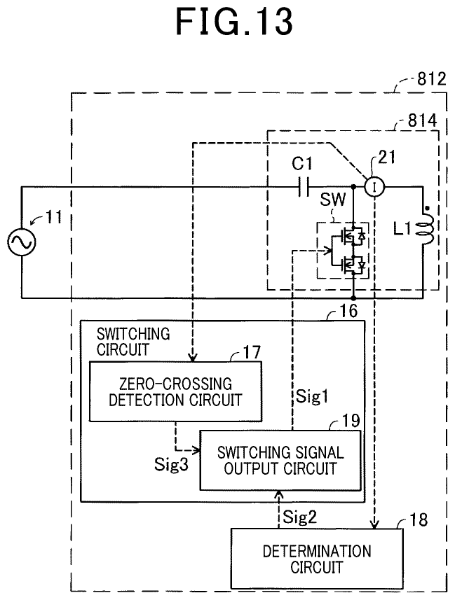

A power transmitting circuit 812 according to an eighth embodiment according to FIG. 13 is different from the above-described embodiments in the circuit configuration of the power transmitting resonant circuit 814. The same components as in the above-described embodiments are labelled with the same reference numerals and a detailed description thereof is omitted, if necessary.

The power transmitting resonant circuit 814 includes the power transmitting coil L1, the power transmitting capacitor C1, and the switch SW. The power transmitting resonant circuit 814 is a series resonant circuit in which the power transmitting coil L1 is connected in series to the power transmitting capacitor C1. The switch SW is a switch for causing short-circuit between terminals of the power transmitting coil L1. Specifically, the switch SW is disposed between one terminal and the other terminal of the power transmitting coil L1. Then, the one terminal and the other terminal of the power transmitting coil L1 are short-circuited by setting the switch SW to the electrically continuous state.

In a case where the power transmitting coil L1 and the power receiving coil L2 are magnetically coupled and the switch SW is set in the electrically discontinuous state, the power transmitting resonant circuit 814 enters the resonant state at the operating frequency. In other words, the capacitance value of the power transmitting capacitor C1 is set to a value at which a resonant frequency of the power transmitting resonant circuit 814 matches the operating frequency. In contrast, in a case where the switch SW is set in the electrically continuous state, short-circuit is caused between the terminals of the power transmitting coil L1, so that the power transmitting resonant circuit 814 enters the non-resonant state at the operating frequency.

The current sensor 21, which serves as the first current sensor, is disposed between the power transmitting capacitor C1 and the power transmitting coil L1. The current sensor 21 detects the current flowing through the power transmitting coil L1.

The switching circuit 16 switches the switch SW between the electrically continuous state and the electrically discontinuous state at the current zero-crossing point, at which the current flowing through the power transmitting coil L1 reaches zero A. This makes it possible to reduce a rapid change in current and, consequently, reduce the generation of radiated noise or conducted noise.

According to the eighth embodiment described hereinabove, it is possible to produce effects similar to those described above and also switch the power transmitting resonant circuit 814 between the resonant state and the non-resonant state by switching the switch SW between the electrically continuous state and the electrically discontinuous state. The power transmitting resonant circuit 814 has one fewer capacitor as compared with the power transmitting resonant circuit 14 according to the first embodiment. As seen from the above, according to the present embodiment, it is possible to configure the power transmitting resonant circuit using a smaller number of passive elements.

### L. Modification of Eighth Embodiment

In the above-described eighth embodiment, the switch SW is disposed at a position allowing for short-circuiting the power transmitting coil L1. As another form, the switch SW may be disposed at a position capable of short-circuiting the power transmitting capacitor C1. In this form, it is also possible to switch the power transmitting resonant circuit 814 between the resonant state and the non-resonant state by switching the switch SW between the electrically continuous state and the electrically discontinuous state.

### M. Other Embodiments

(M1) In the above-described first embodiment, after determining that the voltage zero-crossing point is detected in Step S3, the switching circuit 16 performs switching to the resonant state or the non-resonant state in Step S5. Step S5 is thus performed after the detected voltage value passes the zero-crossing point. As another form, Step S5 may be performed within the voltage zero-crossing range, excluding the voltage zero-crossing point, as described above. In other words, Step S5 illustrated in FIG. 3 may be performed before the detected voltage value reaches the zero-crossing point. Specifically, the switching circuit 16 may perform Step S5 in a case where the detected voltage value enters the voltage zero-crossing range. In a case where the detected voltage value is in the vicinity of the voltage zero-crossing point, switching to the resonant state or the non-resonant state makes it possible to reduce the generation of radiated noise or the like. In the embodiments excluding the first embodiment, Step 5 may also be performed within the current zero-crossing range, excluding the current zero-crossing point, or the voltage zero-crossing range, excluding the voltage zero-crossing point.

(M2) As illustrated in FIG. 4, the detected current value from the current sensor 21 is to be inputted to the determination circuit 18 according to the first embodiment. As another embodiment, for a case where the detected voltage value from the voltage sensor 20 is to be inputted to the determination circuit 18, the determination circuit 18 may also include the effective value output circuit 23. Likewise, in a case where the detected voltage value from the voltage sensor 20 is to be inputted to the determination circuit 18, the determination circuit 18 may include a rectifier circuit. Likewise, the detected current value from the current sensor 21 is to be inputted to the determination circuit 418 according to the fourth embodiment as illustrated in FIG. 9. As another embodiment, for a case where the detected voltage value from the voltage sensor 20 is to be inputted to the determination circuit 418, the determination circuit 18 may also include the peak hold circuit 26.

(M3) In the power transmitting resonant circuit 14 of the above-described first embodiment, the power transmitting capacitor C1 includes the first power transmitting capacitor C11 and the second power transmitting capacitor C12. Then, the power transmitting resonant circuit 14 is to be switched between the resonant state and the non-resonant state by changing the capacitance value of the power transmitting capacitor C1. As another embodiment, the power transmitting resonant circuit 14 may be switched between the resonant state and the non-resonant state by changing the inductance of the power transmitting coil L1. Specifically, in some forms, the power transmitting coil L1 may include two coils connected in series to each other so that the resonant state is set by causing the two coils to be electrically continuous and the non-resonant state is set by causing only one of the two coils to be electrically continuous. Moreover, as another embodiment, the power transmitting capacitor C1 may be implemented by a single variable capacitor.

(M4) The above-described first embodiment employs a so-called S-S scheme circuit configuration, in which in the power transmitting resonant circuit 14, the power transmitting capacitor C1 is connected in series to the power transmitting coil L1, whereas in the power receiving resonant circuit 81, the power receiving capacitor C2 is connected in series to the power receiving coil L2. The circuit configuration of the power transmitting resonant circuit 14 and the circuit configuration of the power receiving resonant circuit 81 are not limited to the S-S scheme. (a) For example, a so-called P-S scheme circuit configuration is also possible, in which in the power transmitting resonant circuit 14, the power transmitting capacitor C1 is connected in parallel to the power transmitting coil L1, whereas in the power receiving resonant circuit 81, the power receiving capacitor C2 is connected in series to the power receiving coil L2. (b) Alternatively, a P-SS scheme circuit configuration is also possible, in which a capacitor connected in parallel to the power transmitting coil L1 is provided in addition to the power transmitting capacitor C1 connected in series to the power transmitting coil L1, and in the power receiving resonant circuit 81, two power receiving capacitors C2 are connected in series to each of both terminals of the power receiving coil L2. (c) Moreover, the power transmitting resonant circuit 14 may include a closed circuit in which a coil and a capacitor are connected in series. The coil of the closed circuit is disposed at a position capable of magnetic coupling to the power receiving coil L2 in a case where the power transmitting coil L1 and the power receiving coil L2 are magnetically coupled. (d) Further, the capacitor of the closed circuit may be connected not in series but in parallel to the coil. (e) Moreover, the power transmitting resonant circuit 14 may include the coil connected in series to the power transmitting coil L1 and a capacitor connected in parallel to the coil. This coil is disposed at a position capable of magnetic coupling to the power receiving coil L2 in a case where the power transmitting coil L1 and the power receiving coil L2 are magnetically coupled.

The present disclosure is not limited to the embodiments and modification examples described above and may be implemented in various configurations within the scope that does not depart from the essence thereof. For example, a technical feature in the embodiments and the modification examples that corresponds to a technical feature in the aspects described in the section “SUMMARY” may be replaced or combined, if necessary, in order to solve part or all of the above-described problems or achieve part or all of the above-described effects. Moreover, a technical feature may be deleted if necessary unless it is described as being essential herein.

The controller, circuit, and method thereof described in the present disclosure may be implemented by a dedicated computer provided by a processor programmed to execute one or a plurality of functions embodied by a computer program, and a memory. Alternatively, the controller, circuit, and method thereof described in the present disclosure may be implemented by a dedicated computer provided by a processor including one or more dedicated hardware logic circuits. Furthermore, the controller and its method described in the present disclosure may be implemented by one or more dedicated computers including a combination of a processor programmed to execute one or a plurality of functions, a memory, and one or more hardware logic circuits. Additionally, the computer program may be stored in a computer-readable non-transitory tangible storage medium as instructions to be executed by a computer.

### N. Other Forms

Features of the present disclosure are as follows.

### (Form 1)

A wireless power transfer device (10) including:
a power transmitting resonant circuit (14, 614, 814) including a power transmitting coil (L1) and a power transmitting capacitor (C1);
a switching circuit (16) configured to switch a state of the power transmitting resonant circuit between a resonant state and a non-resonant state by changing at least either one of an inductance of the power transmitting coil or a capacitance value of the power transmitting capacitor; and
a determination circuit (18, 418) configured to determine whether a facing state in which the power transmitting coil faces the power receiving coil or a non-facing state in which the power transmitting coil does not face the power receiving coil is occurring, in which
the switching circuit is configured to,
after the determination circuit determines that either one of the non-facing state and the facing state transitions to another one of the non-facing state and the facing state,
perform a switching process to switch from either one of the non-resonant state and the resonant state to the other of the non-resonant state and the resonant state within either one of (i) a predetermined voltage zero-crossing range including a voltage zero-crossing point of at least either one of the power transmitting coil or the power transmitting capacitor and (ii) a predetermined current zero-crossing range including a current zero-crossing point of at least either one of the power transmitting coil or the power transmitting capacitor.

### (Form 2)

The wireless power transfer device according to Form 1, further including
at least either one of a first voltage sensor for detecting a voltage value of the power transmitting coil or a second voltage sensor for detecting a voltage value of the power transmitting capacitor, in which
the switching circuit is configured to:
switch the state of the power transmitting resonant circuit between the resonant state and the non-resonant state by changing the capacitance value of the power transmitting capacitor,
in a case where the wireless power transfer device comprises the first voltage sensor, estimate the voltage value of the power transmitting capacitor using a detected voltage value from the first voltage sensor and perform the switching process within the voltage zero-crossing range including the voltage zero-crossing point of the power transmitting capacitor, the voltage zero-crossing point being detected using the estimated voltage value of the power transmitting capacitor; and
in a case where the wireless power transfer device comprises the second voltage sensor, perform the switching process within the voltage zero-crossing range including the voltage zero-crossing point of the power transmitting capacitor, the voltage zero-crossing point being detected using a detected voltage value from the second voltage sensor.

### (Form 3)

The wireless power transfer device according to Form 1, further including
at least either one of a first voltage sensor for detecting a voltage value of the power transmitting coil or a second voltage sensor for detecting a voltage value of the power transmitting capacitor, in which
the switching circuit is configured to:
switch the state of the power transmitting resonant circuit between the resonant state and the non-resonant state by changing the capacitance value of the power transmitting capacitor, and
estimate a current value of the power transmitting capacitor using either one of a detected voltage value from the first voltage sensor and a detected voltage value from the second voltage sensor and perform the switching process within the current zero-crossing range including the current zero-crossing point of the power transmitting capacitor, the current zero-crossing point being detected using the estimated current value of the power transmitting capacitor.

### (Form 4)

The wireless power transfer device according to Form 2 or 3, in which
the determination circuit is configured to
determine whether the facing state or the non-facing state is occurring using the detected voltage value from either one of the first voltage sensor and the second voltage sensor.

### (Form 5)

The wireless power transfer device according to any one of Forms 2 to 4, in which
the determination circuit includes
at least any one of an effective value output circuit configured to output an effective value of the detected voltage value of either one of the first voltage sensor and the second voltage sensor, a peak hold circuit configured to output a maximum value of the detected voltage value of either one of the first voltage sensor and the second voltage sensor, or a rectifier circuit configured to output a rectified wave of the detected voltage value of either one of the first voltage sensor and the second voltage sensor.

### (Form 6)

The wireless power transfer device according to Form 1, further including
at least either one of a first current sensor for detecting a current value of the power transmitting coil or a second current sensor for detecting a current value of the power transmitting capacitor, in which
the switching circuit is configured to:
switch the state of the power transmitting resonant circuit between the resonant state and the non-resonant state by changing the capacitance value of the power transmitting capacitor,
in a case where the wireless power transfer device comprises the first current sensor, estimate the current value of the power transmitting capacitor from a detected current value from the first current sensor and perform the switching process within the current zero-crossing range including the current zero-crossing point, the current zero-crossing point being detected using the estimated current value of the power transmitting capacitor; and
in a case where the wireless power transfer device comprises the second current sensor, perform the switching process within the current zero-crossing range including the current zero-crossing point, the current zero-crossing point being detected using a detected current value from the second current sensor.

### (Form 7)

The wireless power transfer device according to Form 1, further including
at least either one of a first current sensor for detecting a current value of the power transmitting coil or a second current sensor for detecting a current value of the power transmitting capacitor, in which
the switching circuit is configured to:
switch the state of the power transmitting resonant circuit between the resonant state and the non-resonant state by changing the capacitance value of the power transmitting capacitor, and
estimate a voltage value of the power transmitting capacitor using either one of a detected current value from the first current sensor and a detected current value from the second current sensor and perform the switching process within the voltage zero-crossing range including the voltage zero-crossing point of the power transmitting capacitor, the voltage zero-crossing point being detected using the estimated voltage value of the power transmitting capacitor.

### (Form 8)

The wireless power transfer device according to Form 6 or 7, in which
the determination circuit is configured to
determine whether the facing state or the non-facing state is occurring using the detected current value from either one of the first current sensor and the second current sensor.

### (Form 9)

The wireless power transfer device according to any one of Forms 6 to 8, further including
at least any one of an effective value output circuit configured to output an effective value of the detected current value of either one of the first current sensor and the second current sensor, a peak hold circuit configured to output a maximum value of the detected current value of either one of the first current sensor and the second current sensor, or a rectifier circuit configured to output a rectified wave of the detected current value of either one of the first current sensor and the second current sensor.

### (Form 10)

The wireless power transfer device according to Form 1, further including
a magnetic sensor configured to detect a magnitude of a magnetic flux in a vicinity of the power transmitting coil, in which
the switching circuit is configured to estimate at least either one of a voltage value or a current value of the power transmitting capacitor based on a detection value from the magnetic sensor and detect either one of the current zero-crossing point and the voltage zero-crossing point using the at least either one of the estimated voltage value or the estimated current value of the power transmitting capacitor.

### (Form 11)

The wireless power transfer device according to Form 10, in which
the determination circuit is configured to determine whether the facing state or the non-facing state is occurring using the detection value from the magnetic sensor.

### (Form 12)

The wireless power transfer device according to any one of Forms 1 to 11, in which
the determination circuit is configured to output a state signal to the switching circuit in response to determining that either one of the non-facing state and the facing state transitions to the other one of the non-facing state and the facing state,
the switching circuit is configured to repeatedly perform:
a determination process to determine whether the state signal is inputted; and
the switching process configured to be performed after the state signal is determined to be inputted through the determination process, and
after the switching process is performed, the determination process is performed after an elapse of a predetermined standby time.

### (Form 13)

The wireless power transfer device according to any one of Forms 1 to 12, in which
the power transmitting resonant circuit is a series resonant circuit in which the power transmitting coil is connected in series to the power transmitting capacitor,
the power transmitting resonant circuit further includes either one of a switch for causing short-circuit between terminals of the power transmitting coil and a switch for causing short-circuit between terminals of the power transmitting capacitor,
the power transmitting resonant circuit is configured to be set to the resonant state by setting the switch to an electrically discontinuous state and set to the non-resonant state by setting the switch to an electrically continuous state, and
the switching circuit is configured to switch the state of the power transmitting resonant circuit by switching the switch between the electrically discontinuous state and the electrically continuous state.

What is claimed is:

1. A wireless power transfer device comprising:
a power transmitting resonant circuit including a power transmitting coil and a power transmitting capacitor;
a switching circuit configured to switch a state of the power transmitting resonant circuit between a resonant state and a non-resonant state by changing at least either one of an inductance of the power transmitting coil or a capacitance value of the power transmitting capacitor; and
a determination circuit configured to determine whether a facing state in which the power transmitting coil faces the power receiving coil or a non-facing state in which the power transmitting coil does not face the power receiving coil is occurring, wherein
the switching circuit is configured to,
after the determination circuit determines that either one of the non-facing state and the facing state transitions to another one of the non-facing state and the facing state,
perform a switching process to switch from either one of the non-resonant state and the resonant state to another one of the non-resonant state and the resonant state within either one of (i) a predetermined voltage zero-crossing range including a voltage zero-crossing point of at least either one of the power transmitting coil or the power transmitting capacitor and (ii) a predetermined current zero-crossing range including a current zero-crossing point of at least either one of the power transmitting coil or the power transmitting capacitor.

2. The wireless power transfer device according to claim 1, further comprising
at least either one of a first voltage sensor for detecting a voltage value of the power transmitting coil or a second voltage sensor for detecting a voltage value of the power transmitting capacitor, wherein
the switching circuit is configured to:
switch the state of the power transmitting resonant circuit between the resonant state and the non-resonant state by changing the capacitance value of the power transmitting capacitor,
in a case where the wireless power transfer device comprises the first voltage sensor, estimate the voltage value of the power transmitting capacitor using a detected voltage value from the first voltage sensor and perform the switching process within the voltage zero-crossing range including the voltage zero-crossing point of the power transmitting capacitor, the voltage zero-crossing point being detected using the estimated voltage value of the power transmitting capacitor; and
in a case where the wireless power transfer device comprises the second voltage sensor, perform the switching process within the voltage zero-crossing range including the voltage zero-crossing point of the power transmitting capacitor, the voltage zero-crossing point being detected using a detected voltage value from the second voltage sensor.

3. The wireless power transfer device according to claim 1, further comprising
at least either one of a first voltage sensor for detecting a voltage value of the power transmitting coil or a second voltage sensor for detecting a voltage value of the power transmitting capacitor, wherein
the switching circuit is configured to:
switch the state of the power transmitting resonant circuit between the resonant state and the non-resonant state by changing the capacitance value of the power transmitting capacitor, and
estimate a current value of the power transmitting capacitor using either one of a detected voltage value from the first voltage sensor and a detected voltage value from the second voltage sensor and perform the switching process within the current zero-crossing range including the current zero-crossing point of the power transmitting capacitor, the current zero-crossing point being detected using the estimated current value of the power transmitting capacitor.

4. The wireless power transfer device according to claim 2, wherein
the determination circuit is configured to
determine whether the facing state or the non-facing state is occurring using the detected voltage value from either one of the first voltage sensor and the second voltage sensor.

5. The wireless power transfer device according to claim 3, wherein
the determination circuit is configured to
determine whether the facing state or the non-facing state is occurring using the detected voltage value from either one of the first voltage sensor and the second voltage sensor.

6. The wireless power transfer device according to claim 2, wherein
the determination circuit includes
at least any one of an effective value output circuit configured to output an effective value of the detected voltage value of either one of the first voltage sensor and the second voltage sensor, a peak hold circuit configured to output a maximum value of the detected voltage value of either one of the first voltage sensor and the second voltage sensor, or a rectifier circuit configured to output a rectified wave of the detected voltage value of either one of the first voltage sensor and the second voltage sensor.

7. The wireless power transfer device according to claim 3, wherein
the determination circuit includes
at least any one of an effective value output circuit configured to output an effective value of the detected voltage value of either one of the first voltage sensor and the second voltage sensor, a peak hold circuit configured to output a maximum value of the detected voltage value of either one of the first voltage sensor and the second voltage sensor, or a rectifier circuit configured to output a rectified wave of the detected voltage value of either one of the first voltage sensor and the second voltage sensor.

8. The wireless power transfer device according to claim 1, further comprising
at least either one of a first current sensor for detecting a current value of the power transmitting coil or a second current sensor for detecting a current value of the power transmitting capacitor, wherein
the switching circuit is configured to:
switch the state of the power transmitting resonant circuit between the resonant state and the non-resonant state by changing the capacitance value of the power transmitting capacitor,
in a case where the wireless power transfer device comprises the first current sensor, estimate the current value of the power transmitting capacitor from a detected current value from the first current sensor and perform the switching process within the current zero-crossing range including the current zero-crossing point, the current zero-crossing point being detected using the estimated current value of the power transmitting capacitor; and
in a case where the wireless power transfer device comprises the second current sensor, perform the switching process within the current zero-crossing range including the current zero-crossing point, the current zero-crossing point being detected using a detected current value from the second current sensor.

9. The wireless power transfer device according to claim 1, further comprising
at least either one of a first current sensor for detecting a current value of the power transmitting coil or a second current sensor for detecting a current value of the power transmitting capacitor, wherein
the switching circuit is configured to:
switch the state of the power transmitting resonant circuit between the resonant state and the non-resonant state by changing the capacitance value of the power transmitting capacitor, and
estimate a voltage value of the power transmitting capacitor using either one of a detected current value from the first current sensor and a detected current value from the second current sensor and perform the switching process within the voltage zero-crossing range including the voltage zero-crossing point of the power transmitting capacitor, the voltage zero-crossing point being detected using the estimated voltage value of the power transmitting capacitor.

10. The wireless power transfer device according to claim 8, wherein
the determination circuit is configured to
determine whether the facing state or the non-facing state is occurring using the detected current value from either one of the first current sensor and the second current sensor.

11. The wireless power transfer device according to claim 9, wherein
the determination circuit is configured to
determine whether the facing state or the non-facing state is occurring using the detected current value from either one of the first current sensor and the second current sensor.

12. The wireless power transfer device according to claim 8, further comprising
at least any one of an effective value output circuit configured to output an effective value of the detected current value of either one of the first current sensor and the second current sensor, a peak hold circuit configured to output a maximum value of the detected current value of either one of the first current sensor and the second current sensor, or a rectifier circuit configured to output a rectified wave of the detected current value of either one of the first current sensor and the second current sensor.

13. The wireless power transfer device according to claim 9, further comprising
at least any one of an effective value output circuit configured to output an effective value of the detected current value of either one of the first current sensor and the second current sensor, a peak hold circuit configured to output a maximum value of the detected current value of either one of the first current sensor and the second current sensor, or a rectifier circuit configured to output a rectified wave of the detected current value of either one of the first current sensor and the second current sensor.

14. The wireless power transfer device according to claim 1, further comprising
a magnetic sensor configured to detect a magnitude of a magnetic flux in a vicinity of the power transmitting coil, wherein
the switching circuit is configured to estimate at least either one of a voltage value or a current value of the power transmitting capacitor based on a detection value from the magnetic sensor and detect either one of the current zero-crossing point and the voltage zero-crossing point using the at least either one of the estimated voltage value or the estimated current value of the power transmitting capacitor.

15. The wireless power transfer device according to claim 14, wherein
the determination circuit is configured to determine whether the facing state or the non-facing state is occurring using the detection value from the magnetic sensor.

16. The wireless power transfer device according to claim 1, wherein
the determination circuit is configured to output a state signal to the switching circuit in response to determining that either one of the non-facing state and the facing state transitions to the other one of the non-facing state and the facing state,
the switching circuit is configured to repeatedly perform:
a determination process to determine whether the state signal is inputted; and
the switching process configured to be performed after the state signal is determined to be inputted through the determination process, and
after the switching process is performed, the determination process is performed after an elapse of a predetermined standby time.

17. The wireless power transfer device according to claim 1, wherein
the power transmitting resonant circuit is a series resonant circuit in which the power transmitting coil is connected in series to the power transmitting capacitor,
the power transmitting resonant circuit further includes either one of a switch for causing short-circuit between terminals of the power transmitting coil and a switch for causing short-circuit between terminals of the power transmitting capacitor,
the power transmitting resonant circuit is configured to be set to the resonant state by setting the switch to an electrically discontinuous state and set to the non-resonant state by setting the switch to an electrically continuous state, and
the switching circuit is configured to switch the state of the power transmitting resonant circuit by switching the switch between the electrically discontinuous state and the electrically continuous state.
